(19) United States
(12) Patent Application Publication
(10) Pub. No.: US 2024/0144454 A1
(43) Pub. Date: May 2, 2024

(54) SYSTEM AND METHOD FOR ELECTRONIC ALTERED DOCUMENT DETECTION

(71) Applicant: ROYAL BANK OF CANADA, Toronto (CA)

(72) Inventors: Prerna KHURANA, Toronto (CA); Kasturi KUNDU, Toronto (CA); Cathal SMYTH, Toronto (CA); Payam PARKHA, Barrie (CA); Niall RYAN, Toronto (CA); Chuhan CHEN, Pittsburgh, PA (US); Suraj Raju GUNTIMADUGU, Toronto (CA); Ramin AMIRI, Richmond Hill (CA); Anuja SHUKLA, Toronto (CA)

(21) Appl. No.: 18/378,919

(22) Filed: Oct. 11, 2023

Related U.S. Application Data
(60) Provisional application No. 63/420,954, filed on Oct. 31, 2022.

(51) Int. Cl. G06T 7/00; G06T 3/40; G06T 7/11; G06T 7/13

(52) U.S. Cl. CPC G06T 7/0002; G06T 3/403; G06T 7/11; G06T 7/13; G06T 2207/20084; G06T 2207/20132

(57) ABSTRACT

Systems and methods of electronic altered document detection. The system may conduct operations of a method to: retrieve image data representing an alterable document and determine a target region of interest representing a boundary of an alterable parameter associated with the alterable document. The system may conduct operations to generate a tuned region of interest by calibrating the target region of interest based on an object detection model. The tuned region of interest may include a re-dimensioned boundary of the alterable parameter of interest. The object detection model may be prior-trained based on non-standardized alterable documents. The system may conduct operations to generate, based on the tuned region of interest, a prediction value representing whether the alterable document was subject to unauthorized alteration and transmit a signal representing the prediction value for identifying alterable documents for downstream document deconstruction operations.

### CROSS REFERENCE TO RELATED APPLICATIONS

This application claims priority from U.S. provisional patent application No. 63/420,954, filed on Oct. 31, 2022, the entire contents of which are hereby incorporated by reference herein.

### FIELD

Embodiments of the present disclosure generally relate to the field of image data recognition and, in particular, to systems and methods for electronic counterfeit or altered document detection.

### BACKGROUND

Alterable documents may be documents issued by an entity for recording data associated with data fields thereon. For example, a government entity may issue an identity document such as a citizenship certificate or passport, or a government entity may issue a deed document associated with property ownership information.

In some examples, alterable documents may represent a resource transfer document, such as a banking instrument or cheque for transferring resources from a first entity to a second entity. Resource transfer documents may specify a quantity of resources to be transferred to a second entity. Other examples of alterable documents may include contractual agreements, asset vouchers, deeds, among other examples.

In some examples, alterable documents may be physical or hardcopy documents. Computing systems may be configured to digitize alterable documents.

### SUMMARY

The present disclosure describes embodiments of systems and methods for detecting unauthorized alterations of alterable documents based on image data representing such alterable documents.

In some embodiments, systems and methods may be configured for automated image segmentation or object detection based on image data representing alterable documents. The automated object detection may be for identifying regions of interest associated with alterable parameters, such as entity payee name fields or resource quantity fields. Such identification of regions of interest associated with alterable parameters may be conducted without regard to document templates or prior-known positioning or dimensions of regions of interest.

In some embodiments, such identified regions of interest may be provided as inputs to downstream operations for generating a prediction value (based on the identified region of interest) representing whether the alterable document may have been subject to unauthorized alteration.

In some embodiments of object detection models, the processor may identify one or more regions of interest with a high degree of precision, such that a boundary of the region of interest may include only as much as the alterable document as the model considers as representing the ‘payee entity name’, the ‘resource quantity amount’, bibliographical data value/field, or some other alterable parameter. However, in some scenarios, other portions of the alterable document may include image data representing background information that may provide cues desirable for downstream operations for determining whether the alterable document may have been subject to unauthorized alteration.

In some embodiments, upon identifying one or more regions of interest representing particular data attributes, the processor may be configured to reconfigure a dimension of the identified region of interest. For example, the processor may identify the target region of interest (based on object detection model operations), and subsequently generate a tuned region of interest for including one or more surrounding document features. In some embodiments, the processor may incrementally increase the target region of interest. In some embodiments, the processor may re-configure the geometric shape of the target region of interest. By re-configuring the region of interest, methods described herein may contribute to operations for generating downstream predictions (e.g., on whether a document may be fraudulent) and without regard for historical data. Such predictions on whether a document may be fraudulent may be based substantially or only on the image data representing the reconfigured regions of interest.

Features of embodiments of systems and methods will be further disclosed herein.

In one aspect, the present disclosure provides a system for electronic altered document detection. The system may include: a processor; and a memory coupled to the processor. The memory may store processor-executable instructions that, when executed, configure the processor to: retrieve image data representing an alterable document; determine a target region of interest representing a boundary of an alterable parameter associated with the alterable document; generate a tuned region of interest by calibrating the target region of interest based on an object detection model, the tuned region of interest includes a re-dimensioned boundary of the alterable parameter of interest, wherein the object detection model being prior-trained based on non-standardized alterable documents; generate, based on the tuned region of interest, a prediction value representing whether the alterable document was subject to unauthorized alteration; and transmit a signal representing the prediction value for identifying alterable documents for downstream document deconstruction operations.

In another aspect, the present disclosure provides a method for electronic altered document detection. The method may include retrieving image data representing an alterable document; determining a target region of interest representing a boundary of an alterable parameter associated with the alterable document; generating a tuned region of interest by calibrating the target region of interest based on an object detection model, the tuned region of interest includes a re-dimensioned boundary of the alterable parameter of interest, wherein the object detection model being prior-trained based on non-standardized alterable documents; generating, based on the tuned region of interest, a prediction value representing whether the alterable document was subject to unauthorized alteration; and transmitting a signal representing the prediction value for identifying alterable documents for downstream document deconstruction operations.

In another aspect, a non-transitory computer-readable medium or media having stored thereon machine interpretable instructions which, when executed by a processor may cause the processor to perform one or more methods described herein.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a system for electronic altered document detection, in accordance with an embodiment of the present disclosure;

FIG. 2 illustrates a plan view of a resource transfer document, in accordance with an embodiment of the present disclosure;

FIG. 3 illustrates a plan view of a resource transfer document, in accordance with an embodiment of the present disclosure;

FIG. 4 illustrates a flow chart of a method of unauthorized alterations of resource transfer documents, in accordance with embodiments of the present disclosure;

FIG. 5 illustrates a flow chart of a method of training a convolutional neural network based binary classifier for detecting unauthorized alterations of or fraudulent resource transfer documents, in accordance with embodiments of the present disclosure;

FIG. 6 illustrates a flow chart of a method for training an object detection model, in accordance with embodiments of the present disclosure;

FIG. 7 illustrates a flow chart of a method for electronic altered document detection, in accordance with embodiments of the present disclosure;

FIG. 8 illustrates a plan view of a resource transfer document, in accordance with another embodiment of the present disclosure; and

FIG. 9 illustrates a histogram chart illustrating confidence scores associated with generating target regions of interest or tuned target regions of interests based on image data representing resource transfer documents, in accordance with embodiments of the present disclosure.

### DETAILED DESCRIPTION

Alterable documents may be documents issued by an entity for recording data associated with data fields thereon. For example, a government entity may issue an identity document such as a citizenship certificate or passport, or a government entity may issue a deed document associated with property ownership information.

In some examples described in the present disclosure, alterable documents may also be referred to as resource documents. In some examples in the present disclosure, alterable documents may also be referred to as mutable documents. Alterable documents or mutable documents may be example documents that may subject to change, where such change may be conducted by an unauthorized user and where such change may not be desirable by an entity issuing the mutable documents.

In some examples, alterable documents may represent a resource transfer document, such as a banking instrument or cheque for transferring resources from a first entity to a second entity. Resource transfer documents may specify a quantity of resources to be transferred to a second entity. Other examples of resource transfer documents may include contractual agreements, asset vouchers, deeds, among other examples.

In some examples, alterable documents may be physical or hardcopy documents. Computing systems may be configured to digitize resource documents. Digitizing resource transfer documents may, however, provide for opportunities for unscrupulous users to conduct unauthorized alterations to resource documents.

For ease of exposition, embodiments of the present disclosure are described with reference to resource transfer documents, such as banking instruments or cheques for transferring resources or money from one entity to another entity. It may be appreciated that embodiments of the present disclosure are applicable to several other document types issued by an entity for recording data associated with data fields thereon. That is, embodiments of the present disclosure may be desirable in scenarios where verification of legitimacy or integrity of an alterable document or mutable document is useful.

As described, in some examples, alterable documents may be hard copy documents or instruments. Such hard copy documents may be subject to unauthorized alteration by unscrupulous users. For example, an unscrupulous user may attempt to modify a banking instrument for transferring funds, including one of a quantity of the resource transfer (e.g., dollar amount), a payee entity name (e.g., the name in a ‘Pay To’ field), or other details, for a purpose that is unintended by a payor user (e.g., first entity).

It may be desirable to provide systems and methods for identifying unauthorized alteration of alterable documents based on image data representing the alterable documents. In some scenarios, an unauthorized alteration of an alterable document may include a counterfeit document or a document altered by a person other than a payor user. Other examples of unauthorized alteration of an alterable document may be contemplated.

In some embodiments, alterable documents such as resource transfer documents may include a plurality of data fields. Because resource transfer documents may originate from or be issued by any one of various entities, resource transfer documents may be non-standardized documents. Documents originating from different entities may place data fields in unique positions, and such data fields may have non-standard dimensions or sizes. It may be desirable to provide systems and methods of identifying regions of interests representing data fields associated with resource transfer particulars among non-standardized resource transfer documents. It may be desirable to subsequently identify unauthorized alteration of resource transfer documents based on such identified regions of interest representing data fields associated with the resource transfer particulars.

The present disclosure describes embodiments of systems and methods for detecting potentially fraudulent or unauthorized alteration of alterable documents. Methods may include operations for determining regions of interests for alterable documents, where regions of interests may include payee entity fields or resource quantity fields. In some embodiments, operations for conducting image segmentation for identifying regions of interest may be without regard to prior-document template data. Identified regions of interest may be provided as inputs to downstream operations for predicting whether a resource document may be subject to unauthorized alteration and may be fraudulent.

To illustrate embodiments of the present disclosure, resource documents may be described as cheques prepared by a first entity (e.g., payor entity), where a cheque may specify a second entity (e.g., payee entity) and a quantity of resources to be transferred to the second entity. Such examples of cheques may be hard copy documents or instruments. The particular data directing the resource transfer may be handwritten, type-written, or otherwise encoded. It may be understood that resource documents may alternatively be contractual agreements, vouchers, deeds, among other examples of resource documents.

In some scenarios, the first entity user may provide the second entity user (e.g., payee entity) with a hardcopy cheque. The second entity user may submit the cheque to a banking institution for effecting a transfer of a quantity of resources from a first data record (e.g., banking account of payor entity) of the first entity user to a second data record (e.g., banking account of payee entity) of the second entity user.

In some scenarios, the second entity user may submit the cheque to a banking institution. In some scenarios, such a submission may include image data representing an optical depiction of the cheque. For example, the second entity user may generate an image of the cheque using a mobile phone device for submission to the banking institution for cheque verification and resource transfer operations.

In another example, the second entity user may submit the cheque to an automated teller machine (ATM), such that the ATM may generate an image of the cheque for cheque verification and resource transfer operations. Embodiments of systems and methods described in the present disclosure may be for detecting unauthorized alterations of resource transfer documents prior to conducting resource transfers.

As will be described herein, embodiments of systems and methods may be configured to determine one or more regions of interest associated with a resource parameter (e.g., payee entity name field, or resource quantity value). In some examples described in the present disclosure, a resource parameter may be referred to as an alterable parameter. Image data associated with the determined regions of interest may be provided as inputs to a convolutional neural network having fully connected layers for predicting whether the resource transfer document may have been subject to unauthorized alteration or may be fraudulent.

In some embodiments of the object detection model, the processor may identify one or more regions of interest with high degree of precision, such that a boundary of the region of interest may include only as much of the resource transfer document as the model considers as representing the ‘payee entity name’ or the ‘resource quantity amount’.
in some scenarios, portions of the resource transfer document may include image data representing background information that may provide useful cues desirable for downstream operations for determining whether the resource transfer document may have been subject to unauthorized alteration.

Thus, in some embodiments, upon identifying one or more regions of interest representing particular data attributes, the processor may be configured to reconfigure a dimension of the identified region of interest. For example, the processor may identify the target region of interest (based on object detection model operations) and, subsequently, generate a tuned region of interest for including one or more surrounding transfer document features. In some embodiments, the processor may incrementally increase the target region of interest. In some embodiments, the processor may re-configure the geometric shape of the target region of interest.

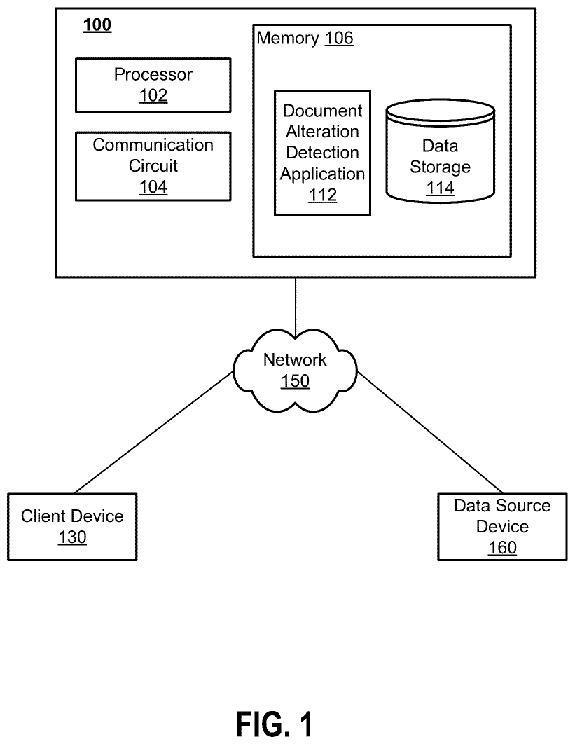

Reference is made to FIG. 1, which illustrates a system 100, in accordance with an embodiment of the present disclosure. In some embodiments, the system 100 may be associated with a banking institution and configured to conduct resource transfer operations.

The system 100 may transmit or receive data messages via a network 150 to or from a client device 130 or a data source device 160. A single client device 130 and a single data source device 160 are illustrated in FIG. 1; however, it may be understood that any number of client devices or data source devices may transmit or receive data messages to or from the system 100.

In some embodiments, the client device 130 may be a smartphone device. The smartphone device may include an image capture device for generating image data representing a resource transfer document. The client device 130 may be operated by a payee entity user, and may be configured to transmit image data of the resource transfer document to the system 100. Submission of image data of the resource transfer document (e.g., an image of a cheque) to the system 100 may represent a request to transfer a quantity of resources specified on the cheque to the second data record associated with the payee entity user.

In some embodiments, the data source device 160 may be an automated teller machine or similar system for receiving hardcopy resource transfer documents, such as hardcopy cheques. The data source device 160 may be configured to generate image data representing the received hardcopy cheques, and generation of the image data may represent a request to transfer a quantity of resources specified on the cheque to the second data record associated with the payee entity user. Other types of data source devices 160 for generating image data representing received hardcopy cheques may be contemplated.

The system 100 may include a document alteration detection application 112 including operations for detecting unauthorized alteration of resource transfer documents based on image data of resource transfer documents.

The system 100 includes a processor 102 configured to implement processor-readable instructions that, when executed, configure the processor 102 to conduct operations described herein.

In some examples, the processor 102 may be a microprocessor or microcontroller, a digital signal processing processor, an integrated circuit, a field programmable gate array, a reconfigurable processor, or combinations thereof. In some embodiments, the processor 102 may be a combination of a central processing unit and an application specific integrated circuit (e.g., a graphics processing unit).

The system 100 includes a communication circuit 104 configured to transmit or receive data messages to or from other computing devices, to access or connect to network resources, or to perform other computing applications by connecting to a network (or multiple networks) capable of carrying data.

The network 150 may include a wired or wireless wide area network (WAN), local area network (LAN), a combination thereof, or other networks for carrying telecommunication signals. In some embodiments, network communications may be based on HTTP post requests or TCP connections. Other network communication operations or protocols may be contemplated.

In some embodiments, the network 150 may include the Internet, Ethernet, plain old telephone service line, public switch telephone network, integrated services digital network, digital subscriber line, coaxial cable, fiber optics, satellite, mobile, wireless, SS7 signaling network, fixed line, local area network, wide area network, or other networks, including one or more combination of the networks. In some examples, the communication circuit 104 may include one or more busses, interconnects, wires, circuits, or other types of communication circuits. The communication circuit 104 may provide an interface for communicating data between components of a single device or circuit.

The system 100 includes memory 106. The memory 106 may include one or a combination of computer memory, such as random-access memory, read-only memory, electro-optical memory, magneto-optical memory, erasable programmable read-only memory, and electrically-erasable programmable read-only memory, ferroelectric random-access memory, or the like. In some embodiments, the memory 106 may be storage media, such as hard disk drives, solid state drives, optical drives, or other types of memory.

The memory 106 may store the document alteration detection application 112 including processor-readable instructions for conducting operations described herein. In some examples, the document alteration detection application 112 may include operations for identifying visual regions of interest of a resource document, and may be configured to conduct operations for predicting whether a resource document is unaltered or legitimate based substantially on image data representing the resource document. In some embodiments, operations for predicting whether a resource document is unaltered or legitimate may be based solely on the image data representing the resource document, and without regard to historical resource transfer data or auxiliary data associated with users.

The system 100 includes data storage 114. In some embodiments, the data storage 114 may be a secure data store. In some embodiments, the data storage 114 may store image data representing resource transfer documents received from at least one of the client device 130 or the data source device 160. In some embodiments, the data storage 114 may store other data sets associated with predicting whether a resource document is unaltered or legitimate and associated with effecting resource transfers.

The client device 130 may be a computing device, such as a mobile smartphone device, a tablet device, a personal computer device, or a thin-client device. The client device 130 may be configured to operate with the system 100 for transmitting data sets associated with resource transfer documents for effecting resource transfers among entity users.

Respective client devices 130 may include a processor, a memory, or a communication interface, similar to the example processor, memory, or communication interfaces of the system 100. In some embodiments, the client device 130 may be a computing device associated with a local area network. The client device 130 may be connected to the local area network and may transmit one or more data sets to the system 100.

The data source device 160 may be a computing device including a processor, a memory, or a communication interface, similar to the system 100. The data source device 160 may be automated teller machines or other types of user input devices for receiving hardcopies of resource transfer documents. For example, the data source device 160 may be associated with a banking institution providing banking accounts to users. The banking institution systems may be configured with operations for facilitating transfer of resources from a first data record associated with a payor entity to a second data record associated with a payee entity.

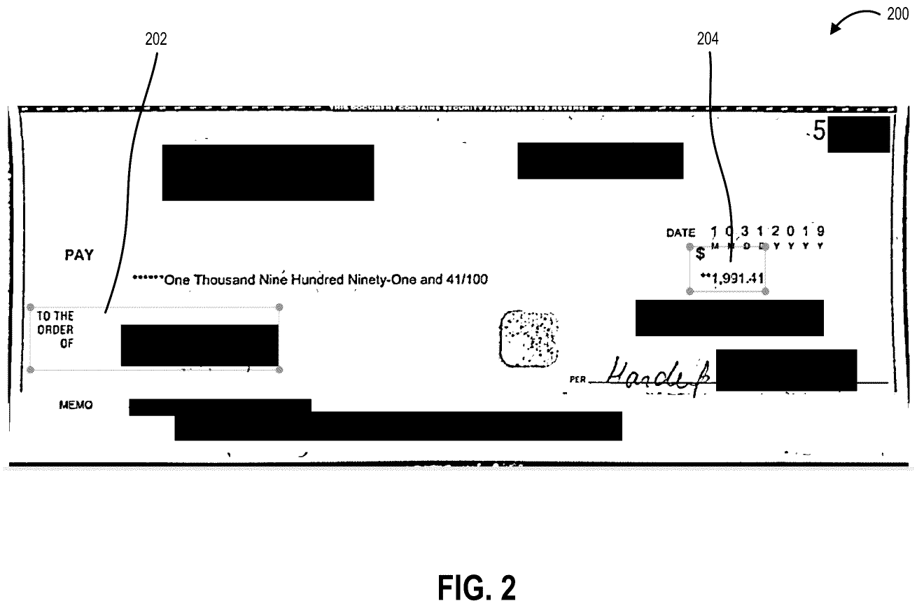

Reference is made to FIG. 2, which illustrates a plan view of a resource transfer document 200, in accordance with an embodiment of the present disclosure. The resource transfer document 200 may be a cheque having a first region of interest 202 representing a payee entity name and a second region of interest 204 representing a quantity of resources that is being directed to be transferred to a data record associated with the payee entity name.

In the illustration of FIG. 2, the first region of interest 202 and the second region of interest 204 may include type written alphanumeric text representing the respective data particulars.

In some scenarios, resource transfer documents may be non-standardized documents. For example, the positioning and size of regions of interest representing particulars of the resource transfer documents may not be at known or template positions.

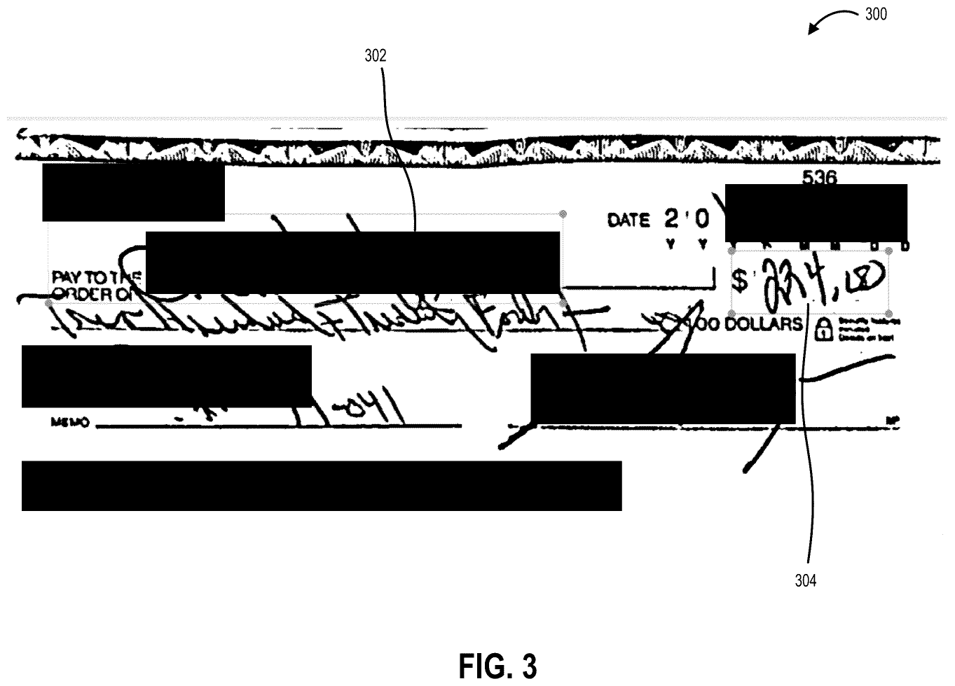

As an illustration, reference is made to FIG. 3, which illustrates a plan view of resource transfer document 300, in accordance with another embodiment of the present disclosure. The resource transfer document 300 may be another example of a cheque having a first region of interest 302 representing a payee entity name and a second region of interest 304 representing a quantity of resources that is being directed to be transferred to a data record associated with the payee entity name. In the illustration of FIG. 3, data particulars of the respective regions of interest are handwritten.

In comparing the resource transfer documents illustrated in FIG. 2 and FIG. 3, it may be appreciated that the positioning or the size of the identified regions of interest are unique. In some scenarios, layouts of resource transfer documents may be non-standard. There may not be fixed templates defining the positioning or size of regions of interest representing respective data particulars.

The present disclosure describes embodiments of systems and methods for identifying and detecting regions of interest representing particular data, such as payee entity name or resource quantity, outlined on a resource transfer document. Embodiments of the present disclosure include operations for identifying or detecting counterfeit or unauthorized alterations of resource transfer documents prior to conducting operations for effecting transfers of resources. Operations for identifying or detecting unauthorized alterations of a resource transfer document may be based on image data representing a particular region of interest and without regard for historical resource transfer data or auxiliary data.

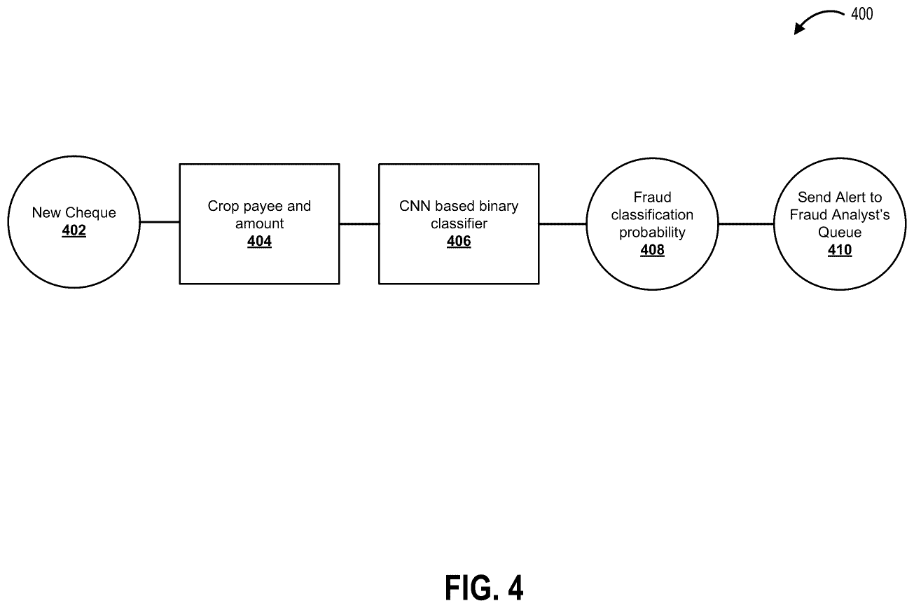

Reference is made to FIG. 4, which illustrates a flow chart of a method 400 of detecting unauthorized alterations of resource transfer documents, in accordance with embodiments of the present disclosure. The method 400 may be conducted by the processor 102 of the system 100 (FIG. 1). Processor-readable instructions may be stored in the memory 106 and may be associated with the document alteration detection application 112 or other processor readable applications not illustrated in FIG. 1. The method 400 may include operations, such as data retrievals, data manipulations, data storage, or the like, and may include other computer executable functions. The method 400 may be based on image data received from one or more of the client device 130 or the data source device 160.

To illustrate features of the present disclosure, the system 100 may be associated with a banking institution, and the system 100 may be configured for processing resource transfer documents, such as cheques, to subsequently conduct resource transfers to be recorded among data records associated with payor entities and payee entities.

At 402, the processor may receive image data representing a resource transfer document. In some embodiments, the image data may be an optical scan of the resource transfer document. In some embodiments, the image data may be an encoded representation of the resource transfer document.

In some embodiments, the image data may be received from a client device 130, such as a smartphone device, associated with a payee entity name. In some embodiments, the image data may be received from a data source device 160, such as an automated teller machine (ATM). A payee entity may submit a hardcopy of a resource transfer document to the automated teller machine, and the automated teller machine may generate image data of the resource transfer document for transmitting the image data to the system 100.

Based on the obtained image data representing a resource transfer document, the processor may, at operation 404, conduct object detection or image segmentation operations for identifying regions of interest associated with data particulars of the resource transfer document. For example, the processor may conduct operations for identifying a first region of interest associated with a payee entity field and a second region of interest associated with a resource quantity field.

In some embodiments, the processor may conduct operations to crop an image of a region of interest associated with a payee entity name and crop an image of a region of interest associated with a specified quantity of resources.

In some scenarios, resource transfer documents may be non-standardized documents. Payee entity fields and resource quantity fields may not be positioned at fixed locations or have known geometric dimensions. At 404, the process may conduct substantial real-time object detection operations for identifying the desired regions of interest representing data particulars.

In some embodiments, the processor may conduct object detection operations based on a substantial real-time object detection model. In some embodiments, object detection models such as YOLO may be used as a foundation or starting point for operations of identifying desired regions of interest representing data particulars.

In some embodiments, the real-time object detection model may conduct operations of an image classifier or image localizer for detecting regions of interest associated with particular data types. In some embodiments, real-time object detection models may include operations of automated image segmentation based on the obtained image data.

Referring again to FIG. 2 and FIG. 3, the processor may, at operation 404, detect regions of interest 202 (FIG. 2), 302 (FIG. 3) in an image associated with a payee entity name, or may detect regions of interest 204 (FIG. 2), 304 (FIG. 3) in the image associated with a resource quantity depicted in the image.

In some embodiments, the object detection model may have been prior-trained based on a selection of training images of resource transfer documents obtained from at least one of client devices 130 or data source devices 160 (FIG. 1). Because resource transfer documents may include non-standardized features associated with positioning or physical size of regions of interest, in some embodiments the selection of training images may include a plurality of varying types of resource transfer documents (e.g., documents originating from a variety of banking institutions).

In some scenarios, there may be a greater likelihood that image data representing resource transfer documents originating from client devices 130 may represent documents having unauthorized alterations. In some embodiments, the selection of training images may include sample resource transfer documents prior-received from client devices 130.

As an example of operations for training the object detection model, the selection of training images may include sample images having manually created bounding boxes identifying regions of interest associated with payee entity name or resource quantity data. Such selection of training images may represent labelled training images.

As an example of operations for training the object detection model, a processor may be trained based on 300 epochs, having a batch size of 64, and having predefined initial weights. In an example where an initial object detection model is a YOLO v5 model, training operations may provide an object detection model having a 98% detection rate for identifying desired regions of interest on a selection of validation images.

In some embodiments of the object detection model, the processor may identify one or more regions of interest with a high degree of precision, such that a boundary of the region of interest may include only as much of the resource transfer document as the model considers as representing the ‘payee entity name’ or the ‘resource quantity amount’.

However, in some scenarios, portions of the resource transfer document may include image data representing background information that may provide cues desirable for downstream operations for determining whether the resource transfer document may have been subject to unauthorized alteration.

Thus, in some embodiments, upon identifying one or more regions of interest representing particular data attributes, the processor may be configured to reconfigure a dimension of the identified region of interest. For example, the processor may identify the target region of interest (based on object detection model operations), and subsequently generate a tuned region of interest for including one or more surrounding transfer document features. In some embodiments, the processor may incrementally increase the target region of interest. In some embodiments, the processor may re-configure the geometric shape of the target region of interest.

As an example, FIG. 3 illustrates an example resource transfer document 300 having handwritten data attributes. The first region of interest 302 represents a payee entity name. Object detection model operations may identify a rectilinear boundary about the metes and bounds handwritten payee entity name. That is, it may be considered inefficient to define the region of interest boundaries beyond the identified metes and bounds of the handwritten payee entity name.

In scenarios where the handwritten text of the payee name has been subject to unauthorized alteration, it may be challenging for downstream operations for identifying such unauthorized alteration without any reference to historical resource transfer data or other auxiliary data. In the present example scenario, it may be beneficial to provide operations for reconfiguring the dimension of the identified target region of interest, such that surrounding or adjacent portions of the resource transfer document may provide additional context for downstream operations for predicting or identifying unauthorized document alteration.

For example, the portion adjacent to the target region of interest 302 representing a handwritten payee entity name may include a handwritten representation spelling out in words of the quantity of a specified resource to be transferred to the payee entity name user. In the present example, downstream operations for predicting whether the resource transfer document has been subject to unauthorized alteration may benefit from such surrounding or adjacent depictions of the target region of interest. Accordingly, in some embodiments, the processor may generate a tuned region of interest by calibrating the target region of interest based on a trained object detection model trained on non-standard resource transfer documents.

In some embodiments, generating the tuned region of interest may include resizing or enlarging the target region of interest for capturing adjacent portions of the resource transfer documents for downstream prediction operations. In some embodiments, generating the tuned region of interest may include selectively concatenating adjacent portions of the resource transfer documents that may include document security features, such as watermarks, holographic images, or other indicia that may be characteristic of unaltered resource transfer documents.

In some embodiments, generating the tuned region of interest may include appending border elements circumscribing the target region of interest, such that the tuned region of interest may have a greater dimensional area. Other operations for generating a tuned region of interest for capturing adjacent portions of the resource transfer documents may be contemplated.

At operation 406, the processor may conduct operations of a convolutional neural network based binary classifier for providing a prediction output representing whether retrieved image data may be a benign or a potentially fraudulent resource transfer document.

In some embodiments, operations for detecting or identifying regions of interest of an image may include identifying regions of interest having a defined fixed two-dimensional pixel size (e.g., payee_Width=1018 pixels, payee_height=273 pixels, and resource_quantity_width=556 pixels, resource_quantity_height=118 pixels). In some embodiments, operations for identifying regions of interest of an image may include generating a tuned region of interest as described in the present disclosure for capturing portions of the resource transfer document that are adjacent to a prior-identified target region of interest (e.g., having a precise metes and bounds area representing a payee entity name). The identified or tuned regions of interest may be provided as inputs to the binary classifier.

In some embodiments, regions of interest may be defined as a maximum size of a payee entity name and resource quantity detected among a selection of training images. Such regions of interest may be provided as training dimensions for providing training inputs to binary classifiers.

In some embodiments, a selection of training images for training the convolutional neural network based classifier may be provided based on a data set or data format in JSON format, where each row may represent a field in an X9 file. The data set may be parsed to provide a respective resource transfer document data type in a row of the parsed data set. In some embodiments, X9 files may be in a data format used for cheque exchanges or clearing houses in Canada based on the Canadian Payments Association, CPA Standard 015. Corresponding data formats for cheque exchanges or clearing houses in the United States or other countries may be contemplated.

At operation 408, the processor may generate a fraud classification prediction or probability value associated with retrieved image data representing a subject resource transfer document. In some embodiments, the fraud classification prediction or probability value may be a value representing a percentage chance that the subject resource transfer document is a potentially fraudulent document, or is a resource transfer document that has been subject to unauthorized alteration.

At operation 410, the processor may generate a signal representing a message for flagging that the subject resource transfer document may require subsequent investigation.

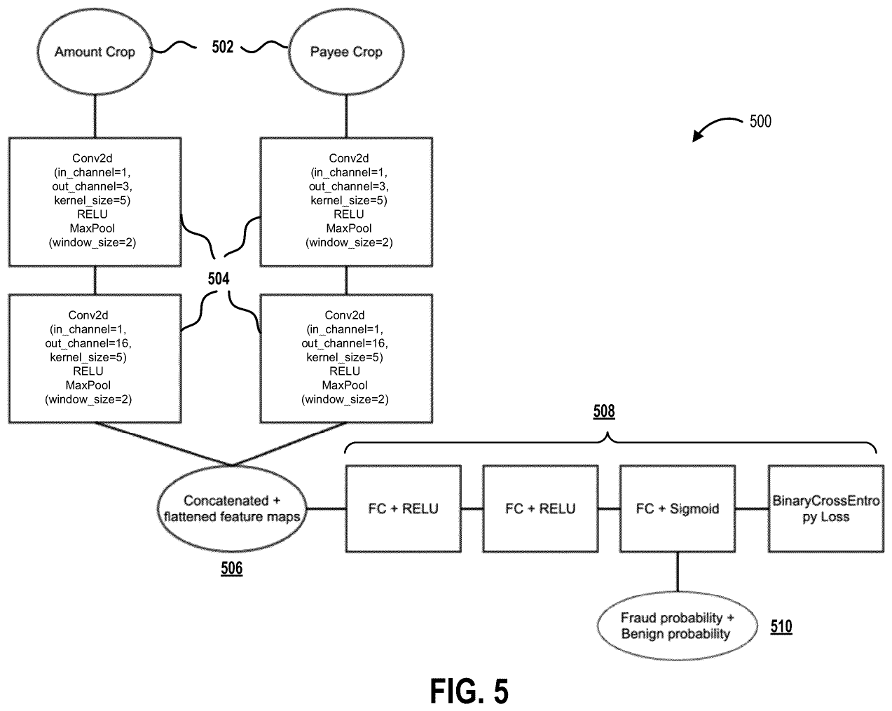

Reference is made to FIG. 5, which illustrates a flow chart of a method 500 of training a convolutional neural network based binary classifier for detecting unauthorized alterations of or fraudulent resource transfer documents, in accordance with embodiments of the present disclosure.

As described herein, in some embodiments, operations may include identifying regions of interest associated with a payee entity name or a resource quantity based on an identified maximum region size that was previously detected among a selection of training images. Such regions of interest may be provided as dimensions for providing training inputs to a binary classifier.

At 502, the processor may obtain image data representing a cropped representation of a payee entity name or a resource quantity value from a respective resource transfer document in a selection of training images.

At 504, the processor may transmit the cropped representations to downstream convolutional layers (conv+RELU+Pool).

At 506, the processor may generate concatenated and flattened feature maps.

At 508, the processor may transmit the flattened and concatenated feature maps to three Fully Connected (FC) layers. In some embodiments, an initial two Fully Connected Layers may be combined with RELU activations, followed by a Fully Connected layer combined with a Sigmoid function. The combination of Connected Layers may be trained based on binary cross entropy loss operations.

At 510, the processor may generate a probability value or a prediction value representing whether the subject resource transfer document may be benign or potentially fraudulent.

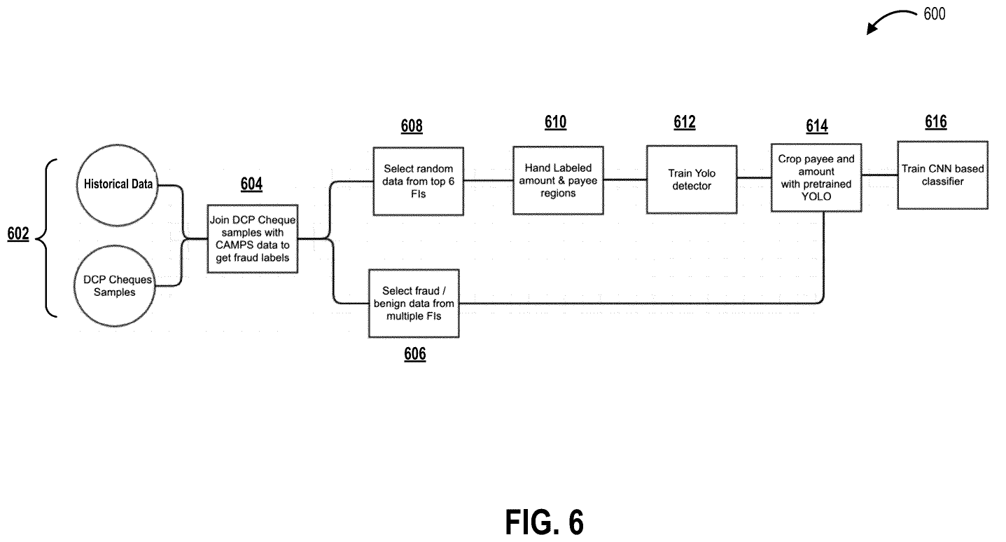

Reference is made to FIG. 6, which illustrates a flow chart of a method 600 for training an object detection model, in accordance with embodiments of the present disclosure. The method 600 may be conducted by the processor 102 of the system 100 (FIG. 1). Processor-readable instructions may be stored in the memory 106 and may be associated with the document alteration detection application 112 or other processor readable applications not illustrated in FIG. 1. The method 600 may include operations, such as data retrievals, data manipulations, data storage, or the like, and may include other computer executable functions. The method 600 may be based on image data received from one or more of the client device 130 or the data source device 160.

At operation 602, the processor may combine digital cheque processing (DCP) cheque sample data and historical fraud detection data. The DCP cheque sample data may be in JSON format, where each row may represent a field in an X9 file. The data set may be parsed to provide a respective resource transfer document data type in a row of the parsed data set. In some embodiments, X9 files may be in a data format used for cheque exchanges or clearing houses in Canada based on the Canadian Payments Association, CPA Standard 015. Corresponding data formats for cheque exchanges or clearing houses in the United States or other countries may be contemplated.

The historical data may represent fraud encountered across a number of operational segments of a banking institution, and the processor at operation 604 may conduct operations of an inner join to generate a labelled data set of image data representing cheque samples.

In some embodiments, the processor may at operation 606 identify fraud/benign data based on image data representing cheques or other resource transfer documents originating from a plurality of banking institutions.

At operation 608, the processor may randomly select image data samples representing cheques from a selected number of banking institutions. The selected number of banking institutions may represent a large volume of institutions responsible for resource transfers in the industry.

In some embodiments, a labeled training data set may be generated by filtering fraud and benign cheque images based on a sampling ratio (e.g., 3:7 or other ratio) representing a plurality of banking institutions and representing receipt from a plurality of user channels (e.g., automated teller machines, mobile image submissions, etc.).

In some embodiments, the processor may retain image data representing regions of interest labelled as counterfeit, altered payee, or altered resource quantity cheque fraud types. Based on such example metadata, the processor may obtain image data representing cheque samples. Such image data may be stored in a base64 string format, or other formats, which may be converted to JPEG format for further downstream operations.

At operation 610, the processor may obtain labeled image data representing hand-labeled regions of interest on resource transfer documents representing payee entity names or resource quantities.

At operation 612, the processor may train an object detection model for identifying target regions of interest representing resource transfer parameters or attributes, such as payee entity name, resource transfer quantity, among other examples of parameters or attributes. In some embodiments, the object detection model may be a modified or re-trained YOLO object detection model for identifying desired regions of interest among resource transfer documents. In the present example, a YOLO object detection model may form a foundation for providing an object detection model suitable for determining target or tuned regions of interest among resource transfer documents.

In some embodiments, the object detection model may be based on version 7 of a YOLO model trained for a graphics processor unit. In the present example, the object detection model may be trained based on a training image data set including at least 1,000 sampled resource document images, where the respective resource document images may be issued by a wide range of entities. The training data set may include a combination of labeled features representing both fraudulent or unauthorized document alterations and representing unaltered documents. In some embodiments, data set labelling may be based on operations of Label Studio™. Other types of data labelling platforms for generating training data sets may be used. In some embodiments, the training data sets may be based on image sizes having dimension of 640 pixels by 640 pixels. Other image or region sizes may be used. In some embodiments, parameters for training the YOLO object detection model may include: epochs=80, batch size=64, and optimizer=Stochastic Gradient Descent. Other parameters associated with training an object detection model may be contemplated for data sets having other features.

At operation 614, the processor may crop regions of interest associated with a payee entity name or a resource quantity associated with a resource transfer specified on a resource transfer document. The cropped region of interest may represent a tuned region of interest representing one or more resource transfer parameters for downstream prediction operations described in the present disclosure.

At operation 616, the processor may transmit the determined tuned region of interest representing one or more resource transfer parameters to a trained convolutional neural network based classifier for generating a prediction on whether a subject resource transfer document may have unauthorized alterations or may be fraudulent.

Testing of embodiments of the present disclosure has been conducted based on a randomly selected quantity of benign cheque images from a plurality of user sources (e.g., client devices 130—mobile cheque image submission; or data source devices 160—automated teller machine submission, among other examples). In some testing scenarios, regions of interest were cropped to fixed region of interest dimensions, where the fixed region of interest dimensions may be based on maximum observed dimensions or statistically correlated observed dimensions (averages, etc.). Downstream operations for predicting fraudulent or unauthorized were conducted to obtain false positive rate values, where a lower false positive rate value is considered favorable. Based on testing of known data sets representing cheque images from known banking entities, proof of concept implementations of embodiments described herein based on fixed dimension and known regions of interest yielded the following results:
percentage of correctly labelled cheques (model accuracy): 92.27%
percentage of fraudulent cheques detected among all fraud cheques (fraud detection rate): 80.7%
% benign cheques falsely tagged as fraud (False Positive Rate): 1.05%

In some examples, documents may be physical or hardcopy documents. Computing systems may be configured to digitize resource documents. Digitizing resource transfer documents may, however, provide opportunities for unscrupulous users to conduct unauthorized alterations of documents.

For ease of exposition, some embodiments of the present disclosure are described with reference to resource transfer documents, such as banking instruments or cheques for transferring resources or money from one entity to another entity.

It may be appreciated that embodiments of the present disclosure are applicable to several other document types issued by an entity for recording data associated with data fields thereon. That is, embodiments of the present disclosure may be desirable in scenarios where verification of legitimacy or integrity of a document is important.

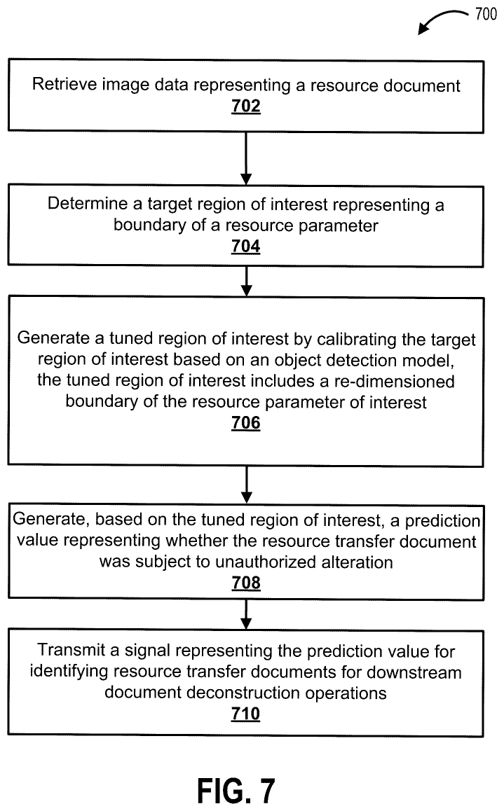

Reference is made to FIG. 7, which illustrates a flow chart of a method 700 for electronic counterfeit or altered document detection, in accordance with embodiments of the present disclosure. The method 700 may be conducted by the processor 102 of the system 100 (FIG. 1). Processor-readable instructions may be stored in the memory 106 and may be associated with the document alteration detection application 112 or other processor readable applications not illustrated in FIG. 1. The method 700 may include operations, such as data retrievals, data manipulations, data storage, or the like, and may include other computer executable functions. The method 700 may be based on image data received from one or more of the client device 130 or the data source device 160.

To illustrate features of the present disclosure, the system 100 may be associated with a banking institution, and the system 100 may be configured for processing alterable or resource transfer documents, such as cheques, to subsequently conduct resource transfers to be recorded among data records associated with payor entities and payee entities. In some embodiments, the system 100 may be configured for operations to examine other types of alterable documents, such as contractual agreements, deeds, asset vouchers, among other types of alterable documents. In some embodiments, alterable documents may include documents generated by a trusted entity having data fields thereon. Detection of potential unauthorized alteration of such documents or alteration of a digitized representation of such documents may be desirable.

In some embodiments described in the present disclosure, a resource document may also be referred to as an alterable document. In some examples in the present disclosure, alterable documents may also be referred to as mutable documents. Alterable documents or mutable documents may be example documents that may subject to change, where such change may be conducted by an unauthorized user and where such change may not be desirable by an entity issuing the alterable or mutable documents.

At operation 702, the processor may retrieve image data representing a resource document. The retrieved image data may be based on image data generated by and received from a smartphone device (e.g., a client device 130 (FIG. 1)). The image data may represent an image of the resource document, such as a cheque, and may have been generated by a smartphone device associated with a payee entity user.

In some embodiments, the retrieved image data may be based on image data generated by an automated teller machine (e.g., a data source device 160 (FIG. 1)). The image data may represent an optical scan of a hardcopy resource document. In some embodiments, the image data may be an encoded representation of the resource document.

At operation 704, the processor may determine a target region of interest representing a boundary of a resource parameter. In embodiments where the resource document is a cheque instrument, the resource parameter may be at least one of a payee entity name or a resource quantity.

In some embodiments, determining the target region of interest representing the boundary of a resource transfer parameter may be based on an object detection model. An example object-detection model may include a YOLO (You Only Look Once) real-time object detection model. In some embodiments, such object detection models may identify one or more regions of interest with a high degree of precision, such that a boundary of the region of interest may include only as much of the resource document as the model considers as representing the “payee entity name’ or the “resource quantity amount”.

In some scenarios, other portions of the resource document may include image data representing background information that may provide cues desirable for downstream operations for determining whether the resource document may have been subject to unauthorized alteration. Thus, in some embodiments, upon identifying one or more regions of interest representing particular data attributes, the processor may be configured to reconfigure a dimension of the identified region of interest. For example, the processor may identify the target region of interest (based on object detection model operations), and subsequently generate a tuned region of interest for including one or more surrounding transfer document features. In some embodiments, the processor may incrementally increase the target region of interest. In some embodiments, the processor may re-configure the geometric shape of the target region of interest.

As an example, FIG. 3 illustrates an example resource transfer document 300 having handwritten data attributes. The first region of interest 302 represents a payee entity name. Object detection model operations may identify a rectilinear boundary about the metes and bounds handwritten payee entity name. That is, it may be considered inefficient to define the region of interest boundaries beyond the identified metes and bounds of the handwritten payee entity name.

In scenarios where the handwritten text of the payee name has been subject to unauthorized alteration, it may be challenging for downstream operations for identifying such unauthorized alteration without any reference to historical resource transfer data or other auxiliary data. That is, the downstream operations may be less precise and may benefit from additional context obtained from other portions or aspects of the resource transfer document.

In the present example scenario, it may be beneficial to provide operations for reconfiguring the dimension of the identified target region of interest, such that surrounding portions of the resource document may provide additional context for downstream operations for predicting or identifying unauthorized document alteration. For example, the portion adjacent to the target region of interest 302 representing a handwritten payee entity name may include a handwritten representation spelling out in words of the quantity of a specified resource to be transferred to the payee entity name user.

In the present example, downstream operations for predicting whether the resource document has been subject to unauthorized alteration may benefit from surrounding or adjacent depictions of the target region of interest.

At operation 706, the processor may generate a tuned region of interest by calibrating the target region of interest based on an object detection model. In some embodiments, the object detection model may have been prior-trained based on non-standardized resource documents.

In examples of resource documents being banking instruments, such as cheques, such banking instruments may have variations of data field placement based on which entity or banking institution may have issued the banking instruments.

In some embodiments, generating the tuned region of interest may include enlarging the boundary circumscribing the target region of interest to include adjacent portions of the resource transfer document providing contextual data for downstream prediction value generation.

In some embodiments, generating the tuned region of interest may include selectively concatenating adjacent portions of the resource transfer documents that may include document security features, such as watermarks, holographic images, or other indicia that may be characteristic of unaltered resource transfer documents.

In some embodiments, generating the tuned region of interest may include appending distal portions of the resource document to complement the determined target region of interest. For example, a document watermark or holographic image may be positionally distant from a particular target region of interest. In the present example, the tuned region of interest may include a combination of the particular target region of interest and the identified distal portion of the resource document.

In some embodiments, generating the tuned region of interest may include appending border elements circumscribing the target region of interest. For example, if the target region of interest is associated with a resource quantity field (e.g., money field), the processor may generate frame or border features around the resource quantity field to provide a larger sized target region of interest. The larger sized target region of interest may correspond to a template sized resource quantity field suitable for downstream prediction operations of the present disclosure.

Other operations for generating a tuned region of interest for capturing adjacent portions of the resource transfer documents may be contemplated.

At operation 708, the processor may generate, based on the tuned region of interest, a prediction value representing whether the resource transfer document was subject to unauthorized alteration.

In some embodiments, generating the prediction value may be based on the tuned region of interest without regard for historical resource transfer data sets. That is, the generated prediction value may be based on a prediction model trained on a selection of training images representing cheques, and the generated prediction value may be based on the identified regions of interest without considering any historical data (e.g., without taking into account data trends that may illustrate deviation from payor's historical transactions, among other examples of historical data).

In some embodiments, generating the prediction value may be based on a convolutional neural network of fully connected layers based on image data representing cropped depictions of the one or more resource transfer parameter.

At operation 710, the processor may transmit a signal representing the prediction value for identifying resource transfer documents for downstream document deconstruction operations. That is, scenarios where the processor identifies that image data representing a particular resource transfer document may be fraudulent or may have been altered by an unauthorized user, the processor may provide a signal to downstream operations for further deconstructing the resource document for additional determination. For example, the further deconstruction of the resource document may include operations for determining based on other features of the resource document whether the document has been altered in an unintended way. In some embodiments, the further deconstruction of the resource document may include operations for seeking verification from an entity issuing the resource document. Other downstream operations for seeking verification on whether the resource document may have been unintended alterations may be used.

In some embodiments, upon determining that a target region of interest representing a boundary of a resource transfer parameter is undetected, the processor may assign the target region of interest to be a fixed dimension boundary associated with a resource transfer parameter of interest. In some embodiments, the fixed dimension boundary may be a predefined position and boundary dimension based on a prior-analysis of maximum or average size region of interest from a selection of training resource transfer document samples.

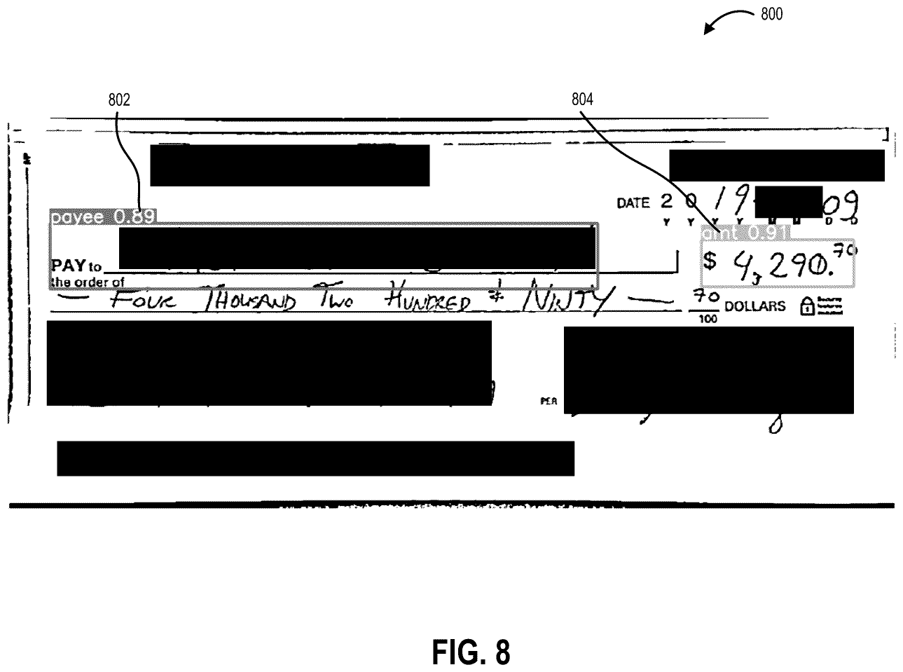

Reference is made to FIG. 8, which illustrates a plan view of a resource transfer document, in accordance with another embodiment of the present disclosure. Upon generating or determining a target region of interest representing a boundary of a resource transfer parameter, a processor may generate annotations for image data representing the resource transfer document. The annotations may represent confidence scores or prediction values associated with a probability that the identified target region of interest is associated with the particular resource transfer parameter (e.g., payee name field or resource quantity).

For example, in FIG. 8, a first confidence score 802 of “0.89” associated with the payee data field is illustrated. A second confidence score 804 of “0.91” associated with a resource quantity field is illustrated.

In embodiments described herein, operations are described as being conducted by a processor, which may include a computing device central processing unit. In some embodiments, operations described herein may be conducted by an application specific integrated circuit devices, such as a graphics processing unit. Conducting embodiments of operations described herein based on specialized circuit devices may increase efficiency and corresponding prediction accuracy.

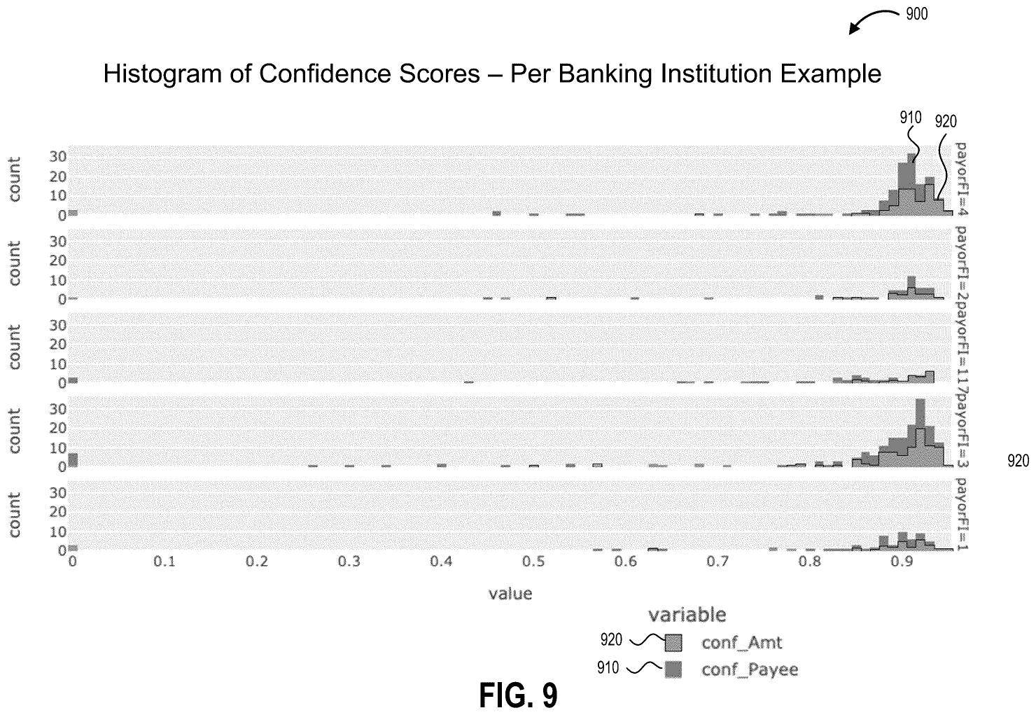

Reference is made to FIG. 9, which is a histogram chart 900 illustrating confidence scores associated with generating target regions of interests or tuned target regions of interests based on image data representing resource transfer documents, in accordance with embodiments of the present disclosure. The histogram chart 900 may illustrate that there is a trend of high probability value that embodiments of operations described in the present disclosure successfully identify regions of interests associated with target resource transfer parameters, such as payee entity name fields or resource quantity amounts. As an example, the histogram chart 900 shows a visual overlay of two sets of confidence scores for resource transfer parameters including entity payee 910 and resource transfer quantity/amount 920.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

As can be understood, the examples described above and illustrated are intended to be exemplary only.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

What is claimed is:

1. A system for electronic altered document detection comprising:
a processor;
a memory coupled to the processor and storing processor-executable instructions that, when executed, configure the processor to:
retrieve image data representing an alterable document;
determine a target region of interest representing a boundary of an alterable parameter associated with the alterable document;
generate a tuned region of interest by calibrating the target region of interest based on an object detection model, the tuned region of interest includes a re-dimensioned boundary of the alterable parameter of interest, wherein the object detection model being prior-trained based on non-standardized alterable documents;
generate, based on the tuned region of interest, a prediction value representing whether the alterable document was subject to unauthorized alteration; and
transmit a signal representing the prediction value for identifying alterable documents for downstream document deconstruction operations.

2. The system of claim 1, wherein generating the tuned region of interest includes enlarging the boundary circumscribing the target region of interest to include adjacent portions of the alterable document providing contextual data for downstream prediction value generation.

3. The system of claim 1, wherein generating the tuned region of interest includes appending border elements circumscribing the target region of interest.

4. The system of claim 1, wherein generating the tuned region of interest includes appending distal portions of the alterable document to complement the determined target region of interest.

5. The system of claim 1, wherein generating the prediction value based on the tuned region of interest is without regard for historical data sets.

6. The system of claim 1, wherein generating the prediction value is based on a convolutional neural network of fully connected layers based on image data representing cropped depictions of the one or more alterable parameter.

7. The system of claim 1, the processor-executable instructions that, when executed, configure the processor to:
upon determining that a target region of interest representing a boundary of an alterable parameter is undetected, assigning the target region of interest a fixed dimension boundary associated with an alterable parameter of interest.

8. The system of claim 1, wherein the alterable document includes a resource transfer document, and wherein the resource parameter of interest includes at least one of a payee entity name field and a resource quantity field of the alterable document.

9. The system of claim 1, wherein the object detection model is based on a real-time object detection model including YOLO (You Only Look Once) retrained for image segmentation of alterable documents.

10. The system of claim 1, wherein the alterable document includes a document generated by a trusted entity having data fields thereon.

11. A method for electronic altered document detection comprising:
retrieving image data representing an alterable document;
determining a target region of interest representing a boundary of an alterable parameter associated with the alterable document;
generating a tuned region of interest by calibrating the target region of interest based on an object detection model, the tuned region of interest includes a re-dimensioned boundary of the alterable parameter of interest, wherein the object detection model being prior-trained based on non-standardized alterable documents;
generating, based on the tuned region of interest, a prediction value representing whether the alterable document was subject to unauthorized alteration; and
transmitting a signal representing the prediction value for identifying alterable documents for downstream document deconstruction operations.

12. The method of claim 11, wherein generating the tuned region of interest includes enlarging the boundary circumscribing the target region of interest to include adjacent portions of the alterable document providing contextual data for downstream prediction value generation.

13. The method of claim 11, wherein generating the tuned region of interest includes appending border elements circumscribing the target region of interest.

14. The method of claim 11, wherein generating the tuned region of interest includes appending distal portions of the alterable document to complement the determined target region of interest.

15. The method of claim 11, wherein generating the prediction value based on the tuned region of interest is without regard for historical data sets.

16. The method of claim 11, wherein generating the prediction value is based on a convolutional neural network of fully connected layers based on image data representing cropped depictions of the one or more alterable parameter.

17. The method of claim 11, comprising: upon determining that a target region of interest representing a boundary of an alterable parameter is undetected, assigning the target region of interest a fixed dimension boundary associated with an alterable parameter of interest.

18. The method of claim 11, wherein the alterable document includes a resource transfer document, and wherein the resource parameter of interest includes at least one of a payee entity name field and a resource quantity field of the alterable document.

19. The method of claim 11, wherein the object detection model is based on a real-time object detection model including YOLO (You Only Look Once) retrained for image segmentation of alterable documents.

20. A non-transitory computer-readable medium having stored thereon machine interpretable instructions which, when executed by a processor, cause the processor to perform a computer implemented method comprising:
retrieving image data representing an alterable document;
determining a target region of interest representing a boundary of an alterable parameter associated with the alterable document;
generating a tuned region of interest by calibrating the target region of interest based on an object detection model, the tuned region of interest includes a re-dimensioned boundary of the alterable parameter of interest, wherein the object detection model being prior-trained based on non-standardized alterable documents;
generating, based on the tuned region of interest, a prediction value representing whether the alterable document was subject to unauthorized alteration; and
transmitting a signal representing the prediction value for identifying alterable documents for downstream document deconstruction operations.
